(19) United States
(12) Patent Application Publication
(10) Pub. No.: US 2011/0101093 A1
(43) Pub. Date: May 5, 2011

(54) DEVICE AND METHOD FOR GENERATING DYNAMIC CREDIT CARD DATA

(75) Inventor: Stina Ehrensvärd, Taby (SE)

(73) Assignee: YUBICO AB, Stockholm (SE)

(21) Appl. No.: 12/674,142

(22) PCT Filed: Aug. 18, 2008
(86) PCT No.: PCT/SE2008/000472

§ 371 Date: Feb. 18, 2010

Related U.S. Application Data
(60) Provisional application No. 60/956,705, filed on Aug. 19, 2007.

(51) Int. Cl. G06Q 20/00; G06K 19/073; G06K 5/00; H04L 9/00

(52) U.S. Cl. 235/380; 235/492; 380/44

(57) ABSTRACT

A portable electronic device adapted to be attached to a computer through a keyboard input port, the portable device having means to generate and automatically output authentication data on request by a user. The output data comprises a by the device generated dynamic code and the code can be automatically inserted into at least one pre-defined field in a credit-card transaction process form.

### BACKGROUND

Credit card fraud is by no means a new phenomenon, but recent year's explosion in on-line services accepting static credit card information have increased the scale and risk for card holders, merchants and card issuers. Apart from the obvious problems and losses resulting from the fraud itself, the discomfort experienced by customers is actually a threat to growth of online services.

Obviously, the credit card issuers are addressing this problem by implementing new schemes to combat fraud, but making a compromise between the level of security and ease of use is a great challenge. Further, given the huge installed base of credit card enabled merchants and web-sites, changing the way credit card information is entered and verified give a complicated implementation process.

Several efforts have been proposed or made to require additional passwords or stronger authentication methods, but in general the implementation issues with requiring the existing infrastructure to be changed have led to no or limited success for these schemes.

Fairly recently, an additional code called the Card Verification Value (CVV) or Card Verification Code (CVC) has been implemented. The CVV code is printed on the backside of the card but is not embossed on the card nor stored on the magnetic stripe. Merchants are not allowed to store the CVV as it shall be verified on-line at all transactions. However, given that the CVV code is static, the security enhancement achieved by this scheme is somewhat questionable.

In US 2008/10110983 (published May 15, 2008) is described a credit card having means for on request by the user pushing a button generating a dynamic card verification value (CVV) and displaying the value on card, which the user subsequently shall enter into the CVV field on the transaction form. A problem with this solution is that the user must read the generated digits and manually enter them onto the transaction form. Another problem is that the device issuing the dynamic code is integrated into the credit card and thereby offers no protection if the credit card as such is stolen.

In WO 2007/122224 is described a device for identification and authentication of a remote user connecting to a service over a network. The device has means for generating and transmitting a cryptographically processed static identification part in conjunction with a dynamic part generated by the device by a command of the device holder. The device can be plugged into a computer via a normal keyboard port.

In implementing security schemes for internet credit card transactions it is desired find solutions which do not require any changes to present web-sites.

### DESCRIPTION OF THE INVENTION

The present invention relates to a portable device having capabilities to generate data related to a standard format credit card transaction, either by generating a part of the data needed for the transaction or by generating the complete set of data needed. An objective of the invention is to generate data that is dynamic by nature, where at least a portion of the generated data has a part that has cryptographic properties.

Another objective of the invention is the convenience aspect, where the slow and error prone manual entry of credit card information can be automated. Depending on the usage scenario and security requirements, all or parts of the credit card identification and authorization data can be automatically outputted by the portable device. The device can be inserted through the means of the keyboard port of a host computer, thereby making use of the device very simple.

Different from solutions using what is known as “Smart Cards”, the usage of a standard USB keyboard port, no additional hardware, such as a card reader is needed. Furthermore, as the standard keyboard protocol is used, no software drivers are needed, allowing the device to be used on various computer platforms.

The device has at least one push-button, where the device holder must physically press the button to generate and output. The button is preferably of a touch type without moving parts to allow a solid-state design without any moving parts. By the means of an oscillator circuit, comprising a resistor-capacitor timing element, a low-cost, high noise-immunity finger proximity sensor can be implemented. The principle relies on the time constant being significantly changed as a finger presses an isolated plate as the capacitance changes.

A portable electronic device adopted to be attached to a computer through a keyboard input port, the portable device having means to generate and automatically output authentication data on request by a user and the output data comprises a by the device generated dynamic code and that the code can be automatically inserted into at least one pre-defined field in a credit-card transaction process form.

The automated transfer of data can be done in various ways:
A small portable hardware device that connects to a keyboard input port of a computer. The device comprises means, like for example buttons, which can be initiated by a user to generate dynamic data and transmit the identification and authentication data to a predefined field on a credit card transaction form.
Software that resides on a client computer can interact with the external portable device and translate the output from the device into emulated keystrokes that are sent though a standard keyboard input software driver.
By the means of a shared memory “clipboard”, where a piece of software residing on the client computer interacts with the external portable device and generates identification and/or authentication information and places into a global “clipboard” buffer. The user can then pick the information from that clipboard and paste it into the appropriate data fields of choice.

A CVV generation scheme can be made to work with legacy, where the device is programmed to never generate the real CVV code that is printed on the cardholder's card. Thereby, transactions can be accepted where the token generated by the portable device is not present and the real CVV is used instead of the dynamic one. The card issuer can then easily distinguish between a “token used” or “token not used” transaction, without the need to explicitly ask the card holder if the token has been used or not. In such a setting, it can be up to the card issuer's policy to still allow transactions but may imply a limit on how large withdrawals that can be made during a specified time interval. On the other hand, certain transaction or certain groups of users can be rejected if the token is not used.

A problem of “Phishing”, where a fraudster manages to collect a generated CVV that is later used in a fraudulent transaction could exist. Therefore the CVV generation token should be made to be time-variant in such a way that a single code has a limited life span. Alternatively, the scheme can be made to be sequential in such a way that codes must be used in a special sequence.

The credit card number itself is static by nature. Together with the “valid thru” fields, the card number can still be used on legacy sites that have not implemented the CVV verification scheme. Even using this data to create fake cards that is used “in real life” can successfully be done, as the CVV code is not used in normal credit card terminals. Yet further, the CVV is typically limited to three or four digits and generating a self-verifying dynamic scheme with such a short number space can be difficult and further security may be desired.

Therefore, another object of the invention is to make the entire credit card information dynamic, optionally even including the “valid thru” field and having a token that is capable of generating it. Several card issuers and banks today offer a “Virtual Card” service, where by the support of a small software applet, a virtual credit card number with a limited life span can be requested. When this number is then used, the bank can then link this virtual number to a real bank account or credit card number to do the actual withdrawal. When the transaction is completed, the virtual credit card number is revoked and is returned to a pool of unused virtual cards. By providing a token, this process can be automated off-line.

Alternatively, a specific portion of a credit card number can be made dynamic together with the valid thru. fields. Assuming a card holder having a special credit card to be used for web-transactions only, then one group would be blank, preferably the one containing the checksum digit. The user would then enter the open fixed part and then yield the last dynamic part, together with the valid thru fields. Thereby, only very few digits would have to be pooled for each unique card holder.

Let's assumethe last digit being a check digit. An example could be:
Printed on the card 1234 5678 9012=cc
Transaction 1, the token generates code 34170911. The complete credit card number would then be 1234 5678 9012 3417, Valid thru 09/11
Transaction 2, the token generates code 95330509. The complete credit card number would then be 1234 5678 9012 9533, Valid thru 05/09
Transaction 3, the token generates code 13450108. The complete credit card number would then be 1234 5678 9012 1345, Valid thru 01/08
. . . and so on. Obviously, the token must be able to generate the check-digit and months and years both being valid. The dynamic part can of course be shorter, for example just one truly dynamic digit and one generated checksum digit, where the valid thru fields vary fully.

By combining this with a dynamic CVV code as well, the risk of collisions is minimized where at the same time the usable number space for dynamic codes is extended.

Alternatively, the token could generate all of the credit card number, where a larger freedom is given how the varying part is composed.

In addition to the above described schemes or implemented separately, sites requiring the cardholder's name as embossed on the card could use this information in a dynamic fashion as well. The token would then generate a dynamic name, apparently not reflecting the card holder's real name, but providing a dynamic field that can be verified by the card issuer. Given the limited usable number space provided by the card number itself.

An example could be:

Transaction 1, generated card holder name WAZKSJDJSK LKLDKJZQNM

Transaction 2, generated card holder name KLEYHBZIKA NZMWQPMZOL

Transaction 3, generated card holder name JHZJQMBKHG JTRMXASKGK

. . . and so on.

The schemes described above all describe a scenario where the credit card information is verified by the card issuer, but the actual flow in a credit-card transaction typically varies. Often, different level of intermediate organizations aggregate transactions and handle them in different ways depending on the issuer and so on. As an alternative to having the card issuer to handle all dynamic data, a proxy party can be involved (which may be the aggregator), which validates the dynamic codes and if the verification is successful, a translation is done through a database lookup, where the card holder's real and static credit-card data is used for verification through the normal secure channel. In such a setting, the real card issuer does not need to care that the information has been translated.

In addition to a single push button for generation and output of the authentication information, a device supporting more than the basic dynamic code generation could have additional buttons. Each additional button would then allow the user to control what shall be outputted depending on the form in question. For example, a device could have three buttons, one to output the card identification string, one to output the card holder name and one to output the Card Verification Code.

Although all schemes are described in the context of web-based forms, it should be apparent that the schemes described can be used in any setting.

In summary, the present invention shows the following benefits
Automatic generation and output of dynamic data
Tamperproof storage of cryptographic information
No battery, no display or open slots allows a rugged design with almost unlimited lifetime
Attaches to standard keyboard port, thereby directly interfacing with present infrastructure without any needs for additional couplers and/or drivers.

### BRIEF DESCRIPTION OF DRAWINGS

FIG. 1 shows a portable device 101 with the form factor of a keychain fob, capable of automatically transfer dynamic credit card information via an USB interface 102. The generation and transfer of dynamic data is controlled by two buttons 103 and 104.

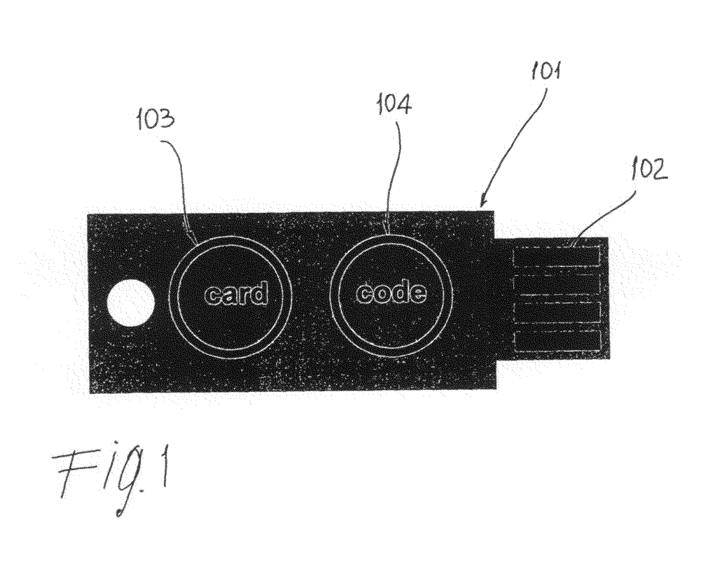

FIG. 2 shows a transaction form 201, typically run in a Web browser, with fields for credit card number 202, valid thru 203 and 204 and CVV code 205

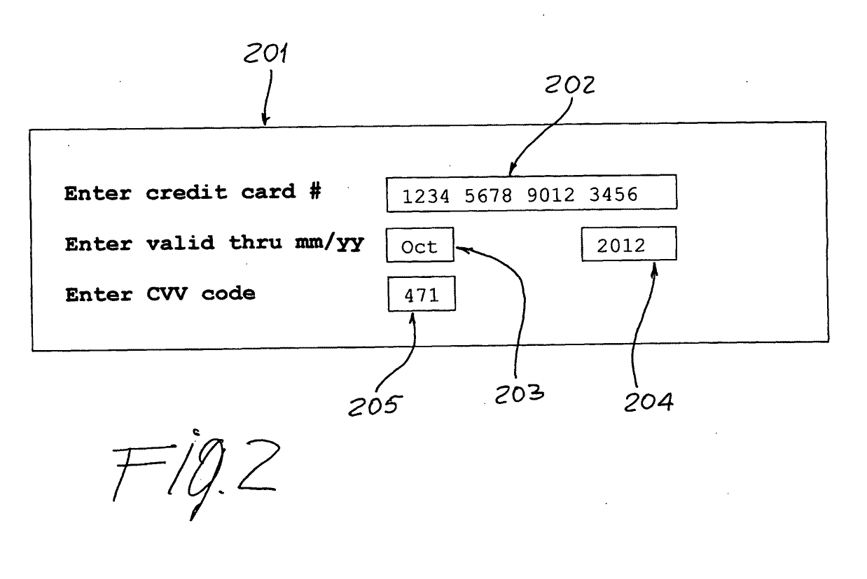

FIG. 3 shows a portable device 301 that connects to a client computer 302 that interacts with a merchant server application 304 via a computer network 303, typically over the Internet. The merchant server application 304 can further communicate with a payment processing application 306 via a computer network 305.

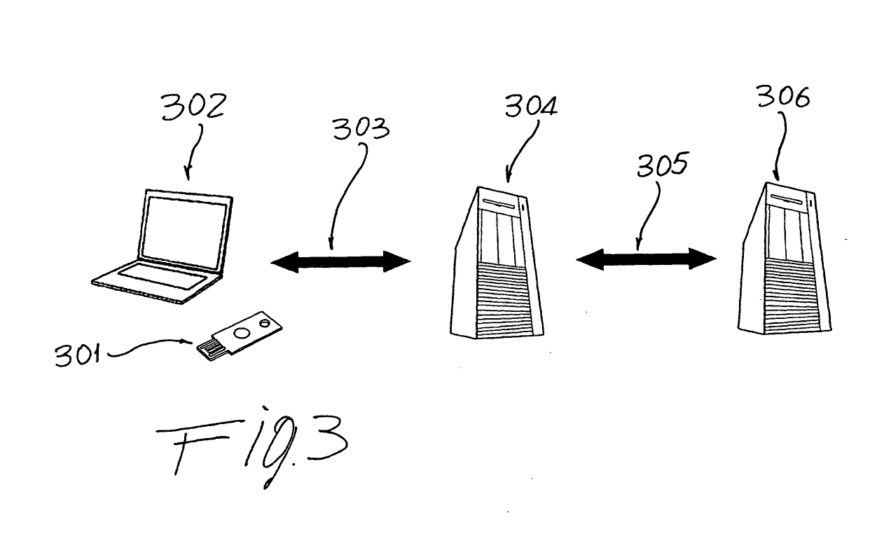

### DETAILED DESCRIPTION OF THE INVENTION

The device 101/301 comprises a cryptographic processor and an USB interface to allow it to be directly connected to an USB “Type A” receptacle via the contact 102 that conforms to the physical constraints of a USB “Type A” plug. When inserted, the device 101/301 identifies itself as a Human Interface Device (HID) keyboard to the computer 302.

As a part of an Internet purchase process, the user (card- and device holder) interacts with a merchant application using a Web browser. When the user is presented to the payment form 201, the cursor is placed in the credit card number field 201. By pressing the device's “card” button 103, the 16-digit card number is automatically outputted as keystrokes by the device into the field.

Depending on the form design and the security requirements, different card holder identification and authentication values can be requested. In this particular example, the card's valid thru fields 203 and 204 are manually entered.

Finally, the user places the cursor in the CVV code field 205 and presses the “code” button 104 on the device. The dynamic CVV code is then calculated and outputted as three digits.

The calculation of the dynamic CVV code typically involves a cryptographic function and at least one cryptographic key, which is stored in a non-volatile memory location in the cryptographic processor. The cryptographic function operates on a time-variant field, such as a linear non-volatile counter that counts up for each code generated. The algorithm itself is not part of the present invention and several algorithms in this field are known, such as the HOTP algorithm described in the IETF RFC 4226 document.

Alternatively, a pre-calculated list of CVV codes can be stored in the device and then be sent one by one as the user requests them. This scheme is known as One Time Pad and when all pre-stored codes have been used, the device expires. The obvious benefit by using the OTP scheme is that no cryptographic processor is needed, but an equally obvious weakness is that a finite number of codes can be generated by the device.

When the result of the cryptographic function has been completed, the result is typically converted to a set of numerical digits. These digits are then outputted one by one as keystrokes through the device's USB keyboard interface.

The user can now press the “Submit” button, sending the form data to the merchant 304 via the computer network 303. The merchant application then creates a payment request to the payment provider application 306 via a computer 305. The payment provider then uses the credit card identification information to select the appropriate cryptographic input data to verify the dynamic CVV code. If valid and there is enough credit on the card, an approval is sent back to the merchant application 304.

The dynamic credit card code could comprise card holder name, credit card number, full or partial, valid thru, CVV code, separate, all together or any combination thereof.

The portable device can be used as an additional item supplementing an existing credit card or it can be used on its own.

Depending on the security requirements, the device may have means for PIN-entry or a biometric scanning device to prevent unauthorized use. Alternatively, the device could be triggered by a simple switch where for example the CVV is used as a PIN. Although less secure, cost savings and simplicity can be achieved. The combination of two devices, preferably with different form factors minimizes the risk of a single-loss. For example, given that a typical card resides in a wallet, a token device may be in the form of a key fob, typically residing in a key chain. Then, two separate devices need to be stolen and the CVV-PIN has to be known in order to successfully perform a transaction.

The dynamic code(s) can be generated by the means of a non-volatile sequencer or having a truly time-variant part, thereby requiring a battery-assisted real-time clock.

In the case of a non-battery assisted device, the dynamic data can either be generated by the means of a cryptographic function together with a cryptographic key and variant field, typically a linear counter.

Alternatively, the device could act as a One-Time-Pad (OTP) device, where a number of pre-stored code sequences are stored in a memory array. As each stored code is being used, that code is discarded and the next one in sequence is used. When all pre-stored codes have been used up, the device expires.

1. A portable electronic device adopted to be attached to a computer through a keyboard input port, the portable device having means to generate and automatically output authentication data on request by a user, characterized by that the output data comprises a by the device generated dynamic code and that the code can be automatically inserted into at least one pre-defined field in a credit-card transaction process form.

2. A device in accordance with claim 1, characterized by that the dynamically generated data is a dynamic Card Validation Value (dCVV) code.

3. A device in accordance with claim 1, characterized by that the dynamic code is generated by the means of a cryptographic operation by using a cryptographic processor and a cryptographic. key, both being integral to the device.

4. A device in accordance with claim 3, characterized by that the cryptographic processor has the ability to exclude at least one predefined value from being generated by the cryptographic processor.

5. A device in accordance with claim 1, characterized by that the dynamic code is being generated by the means of using values in pre-stored list of values, a.k.a. One-Time-Pad in a sequence, said list being an integral part of said device.

6. A device in accordance with claim 5, characterized by that the device comprises means of outputting and transmitting a string of fixed data.

7. A device in accordance with claim 1, characterized by that the device comprises at least one push-button to trigger the output of data.

8. A device in accordance with claim 7, characterized by a plurality of push-buttons where each individual button triggering output of different device authentication data

9. A method for performing a payment transaction on a computer via a pre-defined transaction form and using a credit card, the method comprising the following steps: inserting a portable electronic device into a keyboard port of the computer;
pressing a button on the portable device, thereby initiating generation and transmission of a dynamic code into a pre-defined field on the transaction form;
entering additional static data into other pre-defined fields on the transaction form; transmission of the completed transaction form to a centralized processing authority;
extraction of identification. data from the transaction form to identify and locate locally stored device unique cryptographic information to allow verification of the dynamic code; approval of the transaction given that the verification generates a positive result.
